(19) United States
(12) Patent Application Publication
(10) Pub. No.: US 2025/0155470 A1
(43) Pub. Date: May 15, 2025

(54) EVALUATION CIRCUIT AND METHOD FOR MONITORING AND READING OUT A PASSIVE ROTATIONAL SPEED SENSOR

(71) Applicant: Knorr-Bremse Systeme Fuer Nutzfahizeuge GmbH, Munich (DE)

(72) Inventor: Thomas Feucht, Wimsheim (DE)

(21) Appl. No.: 18/833,148

(22) PCT Filed: Jan. 26, 2023
(86) PCT No.: PCT/EP2023/051863

§ 371 Date: Jul. 25, 2024

(30) Foreign Application Priority Data
Feb. 2, 2022 (DE) 102022102452.0

(51) Int. Cl. G01P 21/00; B60T 8/17; G01P 3/44

(52) U.S. Cl. CPC G01P 21/00; G01P 3/44; B60T 8/1701; B60T 2250/00; B60T 2270/10

(57) ABSTRACT

An evaluation circuit for a passive rotational speed sensor of a vehicle. The passive rotational speed sensor is configured to detect a rotational speed of a wheel and, based thereon, to output a sensor signal. The evaluation circuit includes a first connection and a second connection for electrically connecting the rotational speed sensor a comparator, an operational amplifier, a first signal output and a second signal output. The comparator is configured to compare the sensor signal with a reference voltage and to generate a pulsating output signal based on the comparison. The operational amplifier is configured as a buffer circuit and keeps the reference voltage at a predetermined level. The first signal output and the second signal output are each connected to an output of the comparator to provide the pulsating output signal in a redundant manner for determining the rotational speed of the wheel.

### FIELD OF THE INVENTION

The present invention relates to an evaluation circuit for a passive rotational speed sensor (wheel speed sensor), a method for monitoring and reading out the passive rotational speed sensor, and in particular to an input circuit for passive rotational speed sensors.

### BACKGROUND INFORMATION

Passive rotational speed sensors are used in vehicles, for example, to monitor the speed of wheels for an anti-lock braking system (ABS) or for other vehicle control and regulation systems, in order to enable targeted interventions if a wheel speed does not correspond to a setpoint value. The wheel can be any wheel, such as a magnetic wheel coupled to a braked wheel or a gear wheel (e.g. in the gearbox). Such rotational speed sensors are exposed to considerable environmental influences and must be highly reliable in continuous operation. Malfunctions comprise, for example, short circuits to the supply voltage (e.g. battery voltage) or to ground or a missing connection or incorrect installation. However, the desired high level of operational reliability can only be ensured if damage to the rotational speed sensor is detected in good time.

Specific input circuits are used for this purpose, which on the one hand reliably record the sensor signal of the rotational speed sensor, and on the other hand allow tests for the rotational speed sensor in order to detect faults.

However, conventional input circuits do not yet offer the desired level of reliability, as the sometimes complex integrated circuits offer many sources of interference. As a result, they often cannot be used over longer periods of time (e.g. more than 15 years) without faults. Furthermore, they are often not cost-effective to produce due to their complexity.

Therefore there is a need for input circuits or evaluation circuits in general for passive rotational speed sensors that ensure reliable monitoring and operation during long-term operation.

### SUMMARY OF THE INVENTION

At least part of the above problems may be solved by the evaluation circuit according to the description herein and a method for operating the evaluation circuit according to the description herein. The further descriptions relate to advantageous further embodiments of the subject matter of the main description herein.

The present invention relates to an evaluation circuit for a passive rotational speed sensor of a vehicle (e.g. a commercial vehicle), wherein the passive rotational speed sensor is configured to detect a rotational speed of a wheel, and to generate a sensor signal based thereon. The evaluation circuit comprises a first connection and a second connection for the electrical connection of the rotational speed sensor, a comparator, an operational amplifier, a first signal output and a second signal output. The comparator is configured to compare the sensor signal with a reference voltage, and to generate a pulsating output signal based on the comparison. The operational amplifier is configured as a buffer circuit and keeps the reference voltage at a predetermined level.

The first signal output and the second signal output are each connected to an output of the comparator, in order to provide the pulsating output signal for determining the rotational speed of the wheel redundantly. Furthermore, the comparator is connected to the first connection and the second connection.

Optionally, the comparator comprises a further operational amplifier with an inverting and a non-inverting input, wherein the first connection and second connection are each coupled to one of the inputs, so that the further operational amplifier effectively analyzes a differential signal from an input/output of the passive rotational speed sensor. At the same time, the reference voltage is applied to one of the inputs of the further operational amplifier so that a predetermined voltage level is applied there.

Optionally, the evaluation circuit further comprises a voltage limiter configured to limit the input voltages of the operational amplifier.

Optionally, the operational amplifier is configured as a voltage follower. In particular, the operational amplifier is configured to provide a voltage at low impedance to the comparator. For example, the voltage may be provided at low impedance from a non-inverted input of the operational amplifier to an inverted input of the comparator (an optional resistor may be connected in between). This voltage also serves as a reference voltage for a positive feedback of an output signal of the comparator.

Optionally, the operational amplifier comprises a sensor signal input, a reference signal input, and an output. The sensor signal input is connected to the output. The voltage limiter may have two diodes connected in opposite poles and a current node between the diodes connected in opposite poles can be connected to the output of the operational amplifier in order to safely limit an input voltage of the comparator to its input voltage range (or functional voltage range).

Optionally, the evaluation circuit comprises at least one of the following inputs and outputs:
a test signal input for feeding in a test signal, wherein the test signal input is connected to the first connection and/or to the second connection,
a first status signal output, which is connected to the first connection,
a second status signal output, which is connected to the second connection.

Optionally, the evaluation circuit comprises a control unit configured to receive signals from one or more of the following ports:
the first signal output,
the second signal output,
the first status signal output,
the second status signal output,
the test signal input.

Optionally, the control unit is configured to monitor the passive rotational speed sensor based on the signals received. The control unit may optionally also determine the rotational speed of the wheel, based on the pulsating output signal at the first signal output and/or at the second signal output. However, the speed may also be detected by another unit (e.g. a control unit in the vehicle).

Optionally the control unit is further configured to detect at least one of the following faults:
a short circuit of the first connection to ground,
a short circuit of the second connection to ground,
a short circuit of the first connection to a supply voltage,
a short circuit of the second connection to a supply voltage,
a short circuit between the first connection and the second connection,
a crosstalk between the first connection and the second connection, or a crosstalk between an external signal line to the first connection or to the second connection,
an open electrical connection at the first connection or at the second connection (e.g. a missing or incorrectly connected rotational speed sensor).

The fault can be detected based on signals at at least one of the following outputs:
on the first status signal output,
on the second status signal output,
on the first signal output,
on the second signal output.

In particular, differential signals can also be detected.

Optionally, the first connection or the second connection is connected to a supply connection (e.g. indirectly via at least one resistor), so that in a fault-free state, a voltage is present at the first connection and/or the second connection, or drops between the two connections, even when the wheel is stationary.

Optionally, the control unit is configured to detect the fault by measuring the voltage at the first connection or at the second connection, using the first status signal output or the second status signal output. For this purpose, the control unit may enter a test signal at the test signal input, or not enter a test signal, or set the test signal input to a predetermined potential level (e.g. ground). This allows one of the above-mentioned faults to be detected before the vehicle starts moving, i.e. when the vehicle is at a standstill, or in a low frequency range. In particular, the control unit may also detect the difference signal between the first connection and the second connection (i.e. the voltage drop) in order to detect one of the above-mentioned faults.

Optionally, the evaluation circuit comprises a low-pass filter at at least one of the following outputs or connections:
on the first signal output,
on the second signal output,
on the first status signal output,
on the second status signal output,
between the first connection and the second connection.

This makes it possible to detect with high sensitivity a DC voltage component at status signal outputs. These DC voltage components make it possible to detect short circuits, reverse polarity or a faulty connection of the rotational speed sensor. In addition, the low-pass filters filter out possible interference signals (e.g. from solenoid valves of a brake), which could otherwise lead to faults in the wheel speed detection.

Embodiments also relate to an anti-lock braking system, ABS, for a (commercial) vehicle with at least one passive rotational speed sensor and at least one evaluation circuit described above. In general, at least one rotational speed sensor will be formed for each (braked) vehicle wheel (but there may also be several). The evaluation circuit may, for example, be integrated into an ABS control unit, but it may also be configured separately.

The vehicle does not have to be a commercial vehicle. Embodiments are applicable to and should comprise any vehicle or other application of rotational speed sensors.

Embodiments further relate to a method for monitoring and reading out a passive rotational speed sensor, wherein the method performs an evaluation of signals from the passive rotational speed sensor of a vehicle using an evaluation circuit described above.

Optionally, the method comprises detecting a short circuit and/or a faulty contact and/or a crosstalk. For this purpose, at least one of the following steps can be carried out:
Input of a test signal on the test signal input,
Analysis of a signal status on the first status signal output,
Analysis of a signal status on the second status signal output,
Analysis of a signal on the first signal output and/or on the second signal output, or of a difference signal between the first signal output and on the second signal output.

A faulty contact should in particular also be understood to comprise an open contact, and thus also the absence of the rotational speed sensor.

It is understood that all the functions of the evaluation circuit described above can be configured as further optional process steps. It is also understood that the order in which the steps are mentioned does not restrict the order in which the process steps are carried out. The steps may also be carried out in a different order, or only some of the process steps may be carried out.

Embodiments overcome problems of conventional evaluation circuits. For example, conventional evaluation circuits for passive rotational speed sensors use discrete and integrated input circuits, which have various problems with signal conditioning. In addition, conventional evaluation circuits do not have the ability to provide output signals based on specific test signals. Embodiments overcome these problems and provide a low-cost, testable input circuit for a passive rotational speed sensor.

In particular, the evaluation circuit is used as an input circuit, and (only) discrete components are used, which work very reliably and can be adapted to respective requirements over a very wide range. Further advantages of embodiments include that there are only few problems with mounting the rotational speed sensors in the vehicle, due to a reduction in high-frequency signal components that can be caused by poor wheel speed sensor mounts. Embodiments also enable (analog) filtering of analog feedback signals down to very low frequency ranges, which leads to savings in computer resources for digital filtering of the signals. Otherwise, these signals would have to be digitally filtered at great expense, which would cost computer resources. Embodiments also allow feedback of the sensor amplitude. No special components are required, and a wide variety of tests can be carried out without great effort.

The embodiments of the present invention will be better understood by the following detailed description and accompanying drawings of the various embodiments, which, however, should not be construed as limiting the disclosure to the specific embodiments, but are merely for purposes of explanation and understanding.

### BRIEF DESCRIPTION OF THE DRAWINGS

FIG. 1 shows an evaluation circuit for a passive rotational speed sensor according to an embodiment of the present invention.

FIG. 2 shows an embodiment of the evaluation circuit with further details.

FIG. 3 shows an embodiment of a possible interconnection of the evaluation circuit.

If an element is described below as “connected” or “coupled” to another element, it may be directly connected or coupled to the other element, or there may be other elements in between. In contrast, when an element is described as “directly connected” or “directly coupled” to another element, no intermediate elements are present. Other words used to describe the relationship between elements should be interpreted in the same way (e.g. “between” as opposed to “directly between”, “adjacent” as opposed to “directly adjoining”, etc.).

The terminology used here serves only to describe illustrative embodiments and is not to be understood as restrictive. The singular forms used herein also include the plural forms, unless the context clearly indicates otherwise. It is further understood that the terms “comprise” or “comprising”, when used herein, denote the presence of certain features, steps, operations, elements, and/or components, but do not exclude the presence or addition of one or more other features, steps, operations, elements, components and/or groups thereof.

Unless otherwise defined, all terms used herein (including technical and scientific terms) have the same meaning as commonly understood by a skilled person in the field to which the examples pertain. It is further understood that terms, such as those defined in dictionaries in common use, should be interpreted to have a meaning consistent with their meaning in the context of the relevant field and should not be interpreted in an idealized or overly formal sense unless specifically so defined herein.

Finally, the formulation that elements are connected in series/parallel between two components is to be understood in the sense of an electrical circuit, namely in the sense that the relative position of the components to each other along a current direction is defined, wherein a serial connection or a parallel connection results. The word “between” should therefore not necessarily refer to the physical position or arrangement on a circuit substrate (e.g. printed circuit board).

### DETAILED DESCRIPTION

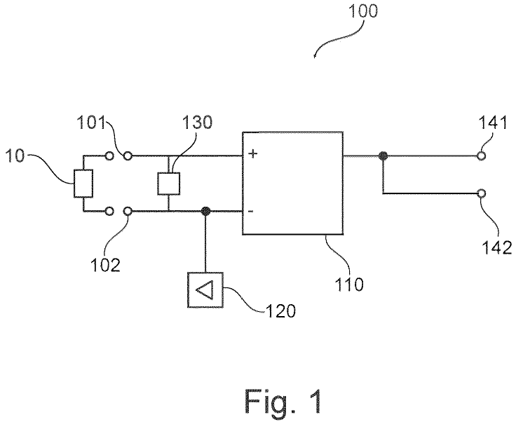

FIG. 1 shows an evaluation circuit 100 for a passive rotational speed sensor 10 according to an embodiment. The evaluation circuit 100 can also be referred to as an input circuit. The passive rotational speed sensor 10 is configured to detect a rotational speed of a wheel, and to generate a sensor signal based thereon. The evaluation circuit 100 comprises a first connection 101 and second connection 102, which are provided for the electrical connection of the rotational speed sensor 10. The evaluation circuit 100 further comprises a comparator 110, which is configured to compare the sensor signal with a reference voltage, and to generate, based on the comparison, a pulsating output signal. The evaluation circuit 100 further comprises an operational amplifier 120, which is configured as a buffer circuit and which maintains the reference voltage at a predetermined level. For example, the reference voltage may be a center voltage (e.g., of the operational amplifier 120 or an amplifier in the comparator 110).

In the circuit of FIG. 1, the buffer circuit 120 is not controlled by a signal at the second connection 102, but provides a reference voltage at low impedance.

The evaluation circuit 100 further comprises a first signal output 141 and a second signal output 142, each of which is connected to an output of the comparator 110, in order to provide the pulsating output signal in a redundant way. This offers the advantage that faults in the signal transmission to downstream circuit components (dirty contacts, leakage currents, interference with neighboring signal transmissions, etc.) can be reliably detected or eliminated.

In the simplest case, the passive rotational speed sensor 10 is a coil in which a periodic electric current is induced by the rotation of a magnetic wheel/gearwheel. The amplitude of this current or a voltage (e.g. across a resistor) is generally not constant, but depends on the rotational speed. Therefore, at higher rotational speeds, for example, there are also larger amplitude values, which makes evaluation more difficult, especially if the same sensitivity is to be achieved for low rotational speeds as for high rotational speeds. Therefore, the evaluation circuit 100 of FIG. 1 optionally comprises a voltage limiter 130, configured to safely limit the input voltage of the comparator 110 to its input voltage range (e.g. 0 V up to the supply voltage of the comparator). In this way, large fluctuations in the amplitude values can be avoided. The dashed representation is intended to indicate that this is an optionally available component.

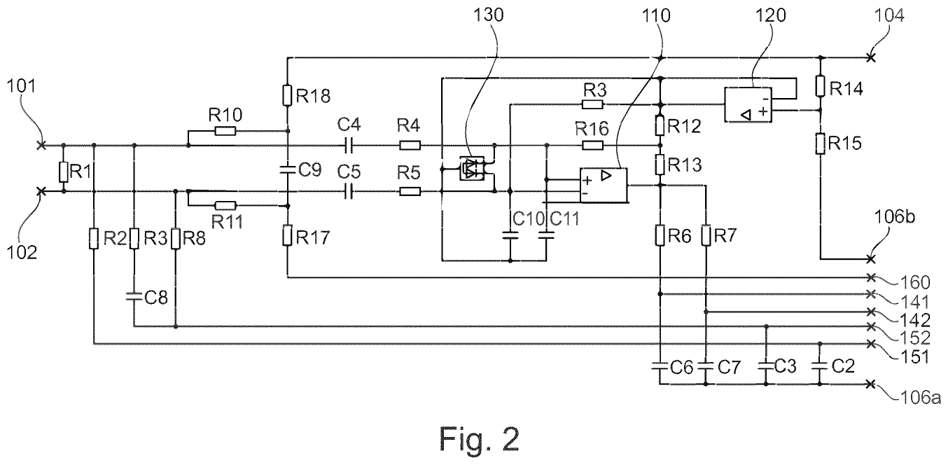

FIG. 2 shows an embodiment of the evaluation circuit 100, which has further details. This evaluation circuit 100 may have the following connections (as input, output or for monitoring): a first connection 101, a second connection 102, a supply connection 104, a first signal output 141, a second signal output 142, a first status signal output 151, a second status signal output 152, a test signal input 160, a first ground connection 106a and a second ground connection 106b. The first ground connection 106a may be a common ground with a downstream microcontroller (control unit). The second ground connection may be, for example, a vehicle ground. They may also be connected to each other. The supply connection 104 may, for example, be used for a connection to a vehicle battery or other power supply.

In addition, the evaluation circuit 100 again comprises the comparator 110, the operational amplifier 120 and the voltage limiter 130 from FIG. 1.

The comparator 110 comprises a reference signal input (−) and a signal input (+). The reference signal input may be an inverted input (−), and the signal input may be a non-inverted input (+) of another operational amplifier (but it may also be the other way around).

The operational amplifier 120 may also have a reference signal input (+) and a signal input (−). For example, the signal input (−) is the inverted input and is connected to the output of the operational amplifier 120. Therefore, the operational amplifier 120 practically does not amplify (G=1), but serves as a buffer circuit to provide a stable reference voltage. In this circuit, the output impedance of the operational amplifier 120 is very low (e.g. less than 10 ohms).

The voltage limiter 130 comprises, for example, a diode arrangement with at least two diodes arranged back to back, which connect the first connection 101 to the second connection 102. A current node between the two diodes may be connected to the output of the operational amplifier 120. As a result of its interconnection, the voltage limiter 130 can safely limit an input voltage of the comparator 110 to an input voltage range of the latter. This is intended to ensure that reliable detection of a sensor signal is always possible. If an input voltage at the comparator 110 were to be too high, the comparator 110 would not be able to output a sensor signal, as the fluctuations would occur below the operating range. This limitation of the input voltage is particularly advantageous for the passive rotational speed sensors used, as these generate sensor signals with speed-dependent amplitudes, and there is therefore a risk that high sensor signals can no longer be reliably detected.

For example, the first connection 101 may be a so-called high-side connection, as it may be connected to the supply connection 104, e.g. in a serial connection of a resistor R10 and a resistor R18. The second connection 102 may, for example, be a so-called low-side connection, and is connected to the test signal connection 160, e.g. in a serial connection of a resistor R11 and a resistor R17.

The first connection 101 and the second connection 102 may also be connected to each other via a resistor R1. A DC voltage component may drop across the resistor R1, which may be generated by connecting the first connection 101 to the supply connection 104 and which may be used for testing purposes (see below). The first connection 101 may be connected to the signal input (+) of the comparator 110 via a serial connection of a capacitor C4 and a resistor R4. The second connection 102 may be connected to the reference signal input (−) of the comparator 110 via a serial connection of a capacitor C5 and a resistor R5. The inverted input may be used as the reference signal input (−), and the non-inverted input may be used as the signal input (+). High-pass filtering can thus be achieved for both connections, wherein the DC voltage component is filtered out.

The output of the comparator 110 may be connected to the output of the operational amplifier 120 via two serially connected resistors, a resistor R12 and a resistor R13. A current node between the resistor R12 and the resistor R13 may be connected to the non-inverted input (+) of the comparator 110 via a resistor R16. The output of the operational amplifier 120 may further be connected to the inverted input (−) of the comparator 120 via a resistor R3. The inverted input (−) of the comparator 110 may further be connected to the output of the operational amplifier 120 via a capacitor C10 connected in series thereafter. In addition, the non-inverted input (+) of the comparator 110 may be connected to the output of the operational amplifier 120 via a capacitor C11.

The non-inverted input (+) of the operational amplifier 120 may be connected to a current node between a resistor R14 and a resistor R15, wherein the resistor R14 and the resistor R15 are both configured to be connected in series between the supply connection 104 and the second ground connection 106b to form a voltage divider. As mentioned above, the operational amplifier 120 is configured to be a voltage follower to provide a voltage, which can be set with the resistor R14 and the resistor R15, to the comparator operational amplifier 110 at low impedance via the resistor R3. This voltage also serves as a reference voltage for coupling the output signal of comparator 110, which is also configured as an operational amplifier, by resistor R12 and resistor R13 via resistor R16 to the non-inverting input (+) of comparator 110.

According to embodiments, the evaluation circuit may comprise various other filter units:

A first low-pass filter may be formed between the output of the comparator 110 and the first signal output 141, wherein a resistor R6 followed by a capacitor C6 connect the output of the comparator 110 to the first ground connection 106a as a serial connection, and the first signal output 141 couples to a current node between the resistor R6 and the capacitor C6. This first filter unit thus represents a low-pass filter for the signal at the first signal output 141.

A second low-pass filter may be formed between the output of the comparator 110 and the second signal output 142, wherein a series connection of a resistor R7 followed by a capacitor C7 is configured from the output of the comparator 110 to the first ground connection 106a, and the second signal output 142 couples to a node between the resistor R7 and the capacitor C7. This second filter unit thus represents a low-pass filter for the output signal at the second signal output 142.

A third low pass filter may be connected between the first connection 101 and the first status signal output 151 and comprises a resistor R2 and a capacitor C2, wherein the capacitor C2 connects the first status signal output 151 to the first ground connection 106a, and the resistor R2 connects the capacitor C2 in series with the first connection 101. This filter unit thus represents a low-pass filter for a signal at the first connection 101 and/or at the first status signal output 151, wherein the resistor R2 effects a current limitation between the first connection 101 and the first status signal output 151 (e.g. during a status test).

A fourth low pass filter may be connected between the second connection 102 and the second status signal output 152 and comprises a resistor R8 and a capacitor C3, wherein the capacitor C3 connects the second status signal output 152 to the first ground connection 106a and the resistor R8 connects the capacitor C3 in series with the second connection 102. This filter unit thus represents a low-pass filter for a signal at the second connection 102 and/or at the second status signal output 152, wherein the resistor R8 effects a current limitation between the second connection 102 and the second status signal output 152 (e.g. during a status test).

The third and fourth low-pass filters can be used to determine the potential DC voltage component present on the first and second connections 101, 102 via the first status signal output 151 and second status signal output 152 respectively. If the DC voltage component does not have an expected value, there is a potential fault, such as a short circuit to ground or a short circuit to the supply voltage. On the other hand, this DC voltage component can be filtered out by the aforementioned high-pass filters C4, R4 or C5, R5 before the inputs of the comparator 110, and thus does not interfere with the rotational speed signal.

A fifth filter unit can be connected between the first connection 101 and the second connection 102 and comprises the resistor R10, a capacitor C9 and the resistor R11 in a serial connection, wherein the capacitor C9 can be arranged in the center. The fifth filter unit is a low-pass filter for a rotational speed signal. This achieves an attenuation, so that the signal voltage only increases slightly over the entire useful frequency range. Passive rotational speed sensors are, in the simplest case, provided by a coil, so that faster changes in the magnetic field induce a stronger sensor signal at higher rotational speeds. As a result, the signal amplitude changes with the rotational speed. Strongly fluctuating signal amplitudes are unfavorable for the subsequent signal evaluation. The fifth filter unit therefore attenuates the high amplitude components (where the high-frequency components are located in particular), using capacitor C9. As a result, the amplitudes of the sensor signal do not fluctuate as much with rotational speed.

It is understood that the circuit components shown are already sufficient for the desired functions. Therefore, further embodiments relate to an evaluation circuit where only the shown components, or a part thereof, are configured to achieve the desired functions. A significant advantage of embodiments is precisely that the functions are enabled by a simple circuit, without the need for complex integrated circuits as used in conventional input circuits. In contrast, embodiments use only discrete components and not multifunctional integrated circuits.

It is also understood that the passive components described here (e.g. resistors and capacitors) have a predetermined, specifically selected characteristic (e.g. resistance values, capacitances) in order to achieve a desired effect. This includes, for example, limiting the current, and filtering out high/low frequency components. The selected resistance values and capacitances of the capacitors naturally depend on the specific rotational speed sensors or the vehicle. They should generally be selected so that the sensor signal can be reliably detected (e.g. from a signal strength of 100 mV), and interference signals can be reliably filtered out. Such interference signals comprise, for example, the switching of solenoid valves (e.g. in the brake system), which can trigger voltage or current pulses.

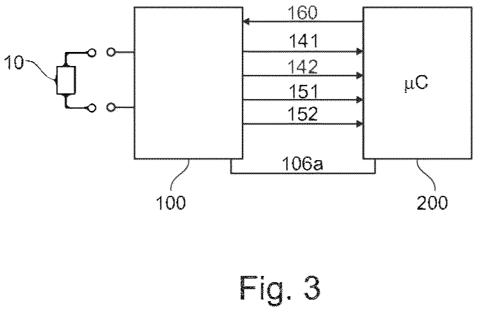

FIG. 3 shows a system setup with the passive rotational speed sensor 10, which may be connected to the first connection 101 and the second connection 102 of the evaluation circuit 100. In addition, the evaluation circuit 100 is connected to a control unit 200, wherein the first ground connection 106a forms a common ground of the evaluation circuit 100 and the control unit 200. The first signal output 141 and the second signal output 142 redundantly provide the output variable from the comparator 110 for the control unit 200. As an example, the control unit 200 is connected to the evaluation circuit 100 via the test signal input 160. In addition, the control unit 200 can be connected to the evaluation circuit 100 via the first status signal output 151 and the second status signal output 152.

According to further embodiments, the control unit 200 may be an optional component of the evaluation circuit 100. However, the control unit 200 may also be configured as a separate component, as shown in FIG. 3.

Embodiments allow the following function to be controlled by the control unit 200:

The first connection 101 can be used to measure a rotational speed sensor voltage (e.g. the DC voltage component) in the low frequency range, for example to check whether the rotational speed sensor 10 has been mounted correctly. For this purpose, the first status signal output 151 can be used, which can measure a voltage level at the first connection 101.

The first and second sensor signal outputs 141, 142 ensure that redundant detection of the sensor signal is possible, so that even if a cable fault should occur on one of the signal lines, reliable speed detection can still take place. The control unit 200 may receive both sensor signals and may indicate a fault in the event of deviations above a tolerance threshold.

According to embodiments, the control unit 200 uses the test signal input 160 to selectively input test signals and determine a fault based on the response. The test signal acts on the first connection 101 and on the second connection 102 via the capacitor C9. A response to the test signal may be received on the one hand via the signal outputs 141, 142. In addition, a response may also be tapped at the first status signal output 151 and/or the second status signal output 152. This allows the following faults to be reliably detected and distinguished from one another: a short circuit of the first connection 101 to ground, a short circuit of the second connection 102 to ground, a short circuit of the first connection 101 to the supply voltage, a short circuit of the second connection to the supply voltage or a short circuit between the first connection 101 and the second connection 102.

If, for example, there is no reaction to a test signal input via the test input 160 at the status signal outputs 151, 152 (e.g. if the voltage level there remains constant), it can be assumed that there is a short circuit to ground or a short circuit to the supply voltage (battery voltage) depending on the potential level present. From the differences between the two status signals present at the first status signal output 151 and the second status signal output 152, conclusions can be drawn as to whether one of the faults mentioned above is present.

Embodiments can be used in particular for anti-lock braking systems for (commercial) vehicles, where (at least) one separate evaluation circuit 100 is provided for each wheel in order to determine the rotational speed of the wheel.

Further embodiments also relate to a method for monitoring and reading out a passive rotational speed sensor, wherein signals from a passive rotational speed sensor 10 of a vehicle are evaluated using the evaluation circuit 100.

In particular, the method may comprise detecting a short circuit and/or a crosstalk. This can be achieved by at least one of the following steps:
input of a test signal at the test signal input 160,
analysis of a signal status at the first status signal output 151,
analysis of a signal status at the second status signal output 152,
analysis of a signal of a signal status at the first signal output 141 and/or the second signal output 142.

It is understood that a test signal does not necessarily have to be entered. According to embodiments, the status at the first connection 101 and the second connection 102 can also be analyzed without the input of a signal (via the status signal outputs 151, 152). Since the first connection 101 is connected to the supply connection 104, a certain voltage should be present there in a fault-free state. If this is not the case, there is a fault, for example.

All the functions of the evaluation unit and/or the control unit 200 described above can form further optionally available process steps (filtering of signals, voltage tracking for the reference voltage, etc.).

The features of the invention disclosed in the description, the claims and the figures may be essential for the realization of the invention either individually or in any combination.

### THE LIST OF REFERENCE SYMBOLS IS AS FOLLOWS

10 rotational speed sensor
100 evaluation circuit
101,102 connections for the rotational speed sensor
104 supply connection (for power supply)
106a first ground connection (e.g. ground of the control unit)
106b second ground connection
110 comparator (e.g. another operational amplifier)
120 operational amplifier
130 voltage limiter
141, 142 signal outputs (redundant)
151, 152 status signal outputs
160 test signal input
200 control unit
R1, R2, . . . various resistors
C1, C2, . . . various capacitors

1-12. (canceled)

13. An evaluation circuit for a passive rotational speed sensor of a vehicle, the passive rotational speed sensor being configured to detect a rotational speed of a wheel and to generate a sensor signal based thereon, comprising:
a first connection and second connection for the electrical connection of the rotational speed sensor;
a comparator which is connected to the first connection and the second connection and is configured to compare the sensor signal with a reference voltage, and to generate a pulsating output signal based on the comparison;
an operational amplifier configured as a buffer circuit to maintain the reference voltage at a predetermined level; and
a first signal output and a second signal output, wherein the first signal output and the second signal output are each connected to an output of the comparator in order to redundantly provide the pulsating output signal for determining the rotational speed of the wheel.

14. The evaluation circuit of claim 13, further comprising:
a voltage limiter configured to limit an input voltage at the comparator to its input voltage range.

15. The evaluation circuit of claim 14, wherein the operational amplifier is configured as a voltage follower so that the reference voltage for the comparator is available at low impedance.

16. The evaluation circuit of claim 15, wherein the operational amplifier includes a sensor signal input, a reference signal input, and an output, and wherein the sensor signal input is connected to the output, and
wherein the voltage limiter has two back-to-back-connected diodes, and a current node between the back-to-back-connected diodes is connected to the output of the operational amplifier to safely limit an input voltage of the comparator to its input voltage range.

17. The evaluation circuit of claim 13, wherein the circuit has at least one of the following inputs or outputs:
a test signal input for feeding in a test signal, wherein the test signal input is connected to the first connection and/or to the second connection, and/or
a first status signal output connected to the first connection, and/or
a second status signal output connected to the second connection.

18. The evaluation circuit of claim 17, further comprising:
a control unit configured to receive signals from one or more of the following ports:
the first signal output,
the second signal output,
the first status signal output,
the second status signal output, and/or
the test signal input;
wherein the control unit is further configured to monitor the passive rotational speed sensor based on the received signals.

19. The evaluation circuit of claim 18, wherein the control unit is further configured to detect at least one of the following faults:
a short circuit of the first connection to ground,
a short circuit of the second connection to ground,
a short circuit of the first connection to a supply voltage,
a short circuit of the second connection to a supply voltage,
a short circuit between the first connection and the second connection,
a crosstalk between the first connection and the second connection or a crosstalk between an external signal line to the first connection or to the second connection, and/or
an open electrical connection at the first connection or at the second connection;
wherein the detection is based on signals at at least one of the following outputs:
the first status signal output,
the second status signal output,
the first signal output, and/or
the second signal output.

20. The evaluation circuit of claim 19, wherein the first connection or the second connection is connected to a supply connection, so that in a fault-free state a voltage drops across the first connection and the second connection even when the wheel is stationary, wherein the control unit is configured to detect the fault by a measurement of the voltage at the first connection or at the second connection using the first status signal output or the second status signal output, and wherein the control unit is further configured to feed in a test signal at the test signal input or not to feed in a test signal.

21. The evaluation circuit of claim 13, wherein a low-pass filter is formed at at least one of the following outputs and connections:
the first signal output,
the second signal output,
the first status signal output,
the second status signal output, and/or
between the first connection and the second connection.

22. An anti-lock braking system (ABS) for a commercial vehicle having at least one passive rotational speed sensor, comprising:
at least one evaluation circuit for a passive rotational speed sensor of the vehicle, the passive rotational speed sensor being configured to detect a rotational speed of a wheel and to generate a sensor signal based thereon, including:
a first connection and second connection for the electrical connection of the rotational speed sensor;
a comparator which is connected to the first connection and the second connection and is configured to compare the sensor signal with a reference voltage, and to generate a pulsating output signal based on the comparison;
an operational amplifier configured as a buffer circuit to maintain the reference voltage at a predetermined level; and
a first signal output and a second signal output, wherein the first signal output and the second signal output are each connected to an output of the comparator in order to redundantly provide the pulsating output signal for determining the rotational speed of the wheel.

23. A method for monitoring and reading out a passive rotational speed sensor, the method comprising:
performing, using an evaluation circuit, an evaluation of sensor signals from the passive rotational speed sensor of a vehicle, wherein the passive rotational speed sensor is configured to detect a rotational speed of a wheel and to generate the sensor signals based thereon, and wherein the evaluation circuit, for the passive rotational speed sensor of the vehicle, includes:
a first connection and second connection for the electrical connection of the rotational speed sensor;
a comparator which is connected to the first connection and the second connection and is configured to compare the sensor signal with a reference voltage, and to generate a pulsating output signal based on the comparison;
an operational amplifier configured as a buffer circuit to maintain the reference voltage at a predetermined level; and
a first signal output and a second signal output, wherein the first signal output and the second signal output are each connected to an output of the comparator in order to redundantly provide the pulsating output signal for determining the rotational speed of the wheel.

24. The method of claim 23, further comprising:
at least one of the following steps for detecting a short circuit and/or a faulty contact and/or a crosstalk:
input of a test signal at the test signal input,
analysis of a signal status at the first status signal output,
analysis of a signal status at the second status signal output, and/or
analysis of a signal at the first signal output and/or at the second signal output, or of a difference signal between the first signal output and the second signal output.
